(19) United States
(12) Patent Application Publication
(10) Pub. No.: US 2007/0021068 A1
(43) Pub. Date: Jan. 25, 2007

(54) User applied template cover for hand-held music player

(76) Inventor: Alfred Dewhurst, Bay Shore, NY (US)

Correspondence Address: Alfred Dewhurst, Apt. 4A, 11 South Saxon Avenue, Bay Shore, NY, 11706, US

(21) Appl. No.: 11/480,297

(22) Filed: Jun. 30, 2006

Related U.S. Application Data
(60) Provisional application No. 60/695,505, filed on Jun. 30, 2005.

(51) Int. Cl. H04B 1/00

(52) U.S. Cl. 455/42; 206/320

(57) ABSTRACT

An adhesive plastic cover for, and in combination with, a hand held portable audio music playback electronic device is preshaped to cover at minimum the front, rear, top and bottom surfaces of the music playback device. A strip in a midsection of the cover corresponds to the top surface of the music player. An opening in the strip corresponds to an opening in the top surface of the music player for allowing centering of the cover on the top surface of the music player. Thereafter, the cover is wrapped around at minimum the front, rear and bottom surfaces of the music player, which is held in a recessed cradle during installation.

### RELATED APPLICATIONS

This application claims benefit in part under 35 U.S.C. 119(e) from provisional Application No. 60/695,505 filed Jun. 30, 2005, the entire disclosure of which is incorporated by reference herein.

### FIELD OF THE INVENTION

The present invention relates to thin, user-applied template covers for music playback devices, such as the Apple® iPod®.

### BACKGROUND OF THE INVENTION

Existing protective covers are designed to guard and protect the front, back, top and bottom surfaces of the music player: i.e. Apple® iPod® include covers which are shaped like an Apple® iPod®, but which typically leave a circular hole to provide manual finger access to the touch sensitive control wheel of the Apple® iPod®.

Among such devices include those offered under the brand names of MacSkinz®, iPod® Shuffle Skin Tattoo Set, Hewlett Packard Q6625A Protection Skin, or iSkin™eXo².

These devices are frequently of materials such as leather, silicone or even thin decal material. The purpose for leaving the cutout is that it is believed that actual finger access to the touch sensitive control wheel is needed.

However, when left open, the circular seam around the touch sensitive control wheel provides an access area for water and other contaminants to infiltrate into the inside of the music player and cause damage thereto.

Another device is an adhesive bearing screen protector substrate entitled Martin Fields Overlay Plus Screen Protector for an iPod® 4G. However, this thin transparent substrate only protects the viewing screen display, not the exterior housing or touch sensitive control wheel of a music player.

### OBJECTS OF THE INVENTION

It is therefore an object of the present invention to provide a user applied protective cover for a music player, such as an Apple® iPod®, which covers the touch sensitive control wheel, while permitting manual operation thereof.

It is also an object to improve over the disadvantages of the prior art.

### SUMMARY OF THE INVENTION

In keeping with these objects and others which may become apparent, the template for the music player, such as the Apple® iPod® or Apple® Mini-iPod® offers a solution to achieve a consistent manufactured copy of an adhesive plastic protective cover designed to guard and protect the entire front, back, top and bottom surfaces of the music player: i.e. Apple® iPod®. Currently two versions of the Apple® iPod® are candidates for the transparent adhesive plastic protective cover (APPC.), the Apple® iPod®, and Apple® mini iPod®. Both models of the Apple® iPode will maintain complete functionality of the touch sensitive controls located on the face of each unit. The APPC is installed without interference to the audio connection, power supplies, and available docking devices including exterior hard case protection systems. The template allows for mass production of an APPC that will protect and help maintain the new surface appearance by creating a transparent barrier between the music player surface and direct contact with normal environment conditions. The foremost attribute of the APPC will be the ability to guard against scratches and abrasions during normal consumer use.

Reason for Appeal of APPC

The Apple® iPod® music player has had extremely strong popularity during the last two years for many reasons. Three significant reasons for this appeal are the ease of operation, the pleasure of the visual appearance, and the direct tactile feel of the device in the consumer's hand. [The APPC allows consumers to continue to enjoy the natural feel of the Apple® iPod® music player in their hands without worry of inflicted surface abrasions and scratches during normal use without interference of an exterior hard case.] In addition to scratch protection, moisture and airborne dust particles are blocked from entry to the inner electronic components located beneath the touch sensitive controls of both models. The ability to help block moisture penetration through the front panel will be a strong consumer point of satisfaction due to the popularity of the use of the music player during workouts at physical fitness centers and gyms. Currently the consumer has several available options for protection that are considerably more difficult to manufacture. The APPC option provides an alternative method of protection without costly manufacturing procedures of the exterior hard case system. The retail cost should be significantly less expensive than the exterior hard case system of protection; however, the APPC is fully compatible with the existing available hard case systems.

APPC Packaged Product

The consumer is guided through the bonding process by simple, easily understood pictorial illustrations and written instructions at each step of the bonding procedure. Included within the clear case package of the APPC is an alignment and centering pin necessary to obtain the correct center of the APPC to the center of the music player's top bonding surface. Also included as part of the clear case package bonding kit is the Apple® iPod® music player holding and support location. The clear case package forms the Apple® iPod® music player holding and support location. The Apple® iPod® music player holding and support location is designed to assist the consumer by allowing the music player to be in a upright stable position while the consumer begins and completes the first and second bonding procedures at the top surface of the music player.

The smallest current iPod® model is the Nano®. It is quite small (1.6″×3.5″×0.27″) and light weight. Because of its small size and light weight, it would be most likely to benefit by the APPC of this invention. Two different embodiments especially designed for the Nano® but equally adaptable to the larger models of iPod® are also part of this invention. Both of the embodiments use a single adhesive plastic protective cover for the front and an optional identical cover for the back side. They differ in the design of the as-purchased APPC and the method of application. In the first of this pair of embodiments, a sheet of plastic cover material with attached release liner is provided. The sheet has a window cut out of the release liner leaving a release liner border on all four edges. The window is the same size needed to cover the front (or the back) of the particular sized iPod® for which it was designed. The edge of the window is also perforated through the transparent cover material for easy separation, without tools, of the border. The procedure for attachment is to first remove the panel of release liner inside the window portion thereby exposing the adhesive layer. Then the sheet is inverted over the front (or back) of the iPod® and carefully aligned with the iPod® edge prior to pushing it down on the iPod® surface. Then, the APPC is smoothed over the surface for good adhesion and the edge of the sheet is separated from the attached APPC panel at the perforations.

The second of the pair of embodiments is sold as a sheet of the same size as the front (or rear) panel of the iPod® to which it will be applied. The sheet has no border, with the APPC plastic layer on one side and a release liner on the back attached to the adhesive layer. The release liner is cut with a broad strip in the center along the long axis with a narrow strip along side each long edge. Application requires the user to first remove the central panel exposing the adhesive layer. The APPC panel is further handled by holding it by the side edges which are still protected by release liner over the adhesive layer. It is then simply inverted and carefully aligned with an edge of the iPod®. After alignment, the first protected edge is held against the edge of the top (or bottom) surface and the adhesive layer is brought into contact with the iPod® surface and smoothed from the center outward to the protected edges. Then, the protected sides are folded over so that the edge release liner strips can be removed. Then the edges are carefully smoothed down.

### BRIEF DESCRIPTION OF THE DRAWINGS

The present invention can best be understood in connection with the accompanying drawings. It is noted that the invention is not limited to the precise embodiments shown in drawings, in which:

FIG. 1 is an exploded perspective view of the template and holding base of the music player protective cover of the present invention;

FIG. 2 is a top plan view showing initial alignment of the music player protective cover upon the top of the music player;

FIG. 3 is a perspective view thereof showing the protective cover partially in place over a music player supported in the holding base;

FIG. 4 is a is a perspective view thereof showing the protective cover;

FIG. 5 is a perspective view thereof showing the protective cover being wrapped around the music player;

FIG. 6 is a perspective view thereof showing the final wrapping of the protective cover over the bottom of the music player; and, FIG. 7 is a perspective view of the covered music player, showing the music player covered on its front rear, top and bottom surfaces.

FIG. 8 is a perspective view of an alternate embodiment for a holding cradle for an application of a template cover for a music player in a horizontally oriented position;

FIG. 9 is a perspective view showing application of a first surface of the template cover to the music player in FIG. 8;

FIG. 10 shows the template cover being further applied to the music player;

FIG. 11 is an alternative perspective view of FIG. 10;

FIG. 12 shows the final release liner removal from the template cover for the music player for the back surface installation as in FIGS. 8-11;

FIG. 13 shows removal of the first release liner of the front panel and its alignment at the seam of the music player;

FIG. 14 is a perspective view of a modified holding base which also serves as an alignment aid during attachment of the APPC panels;

FIG. 15 is an end view of the modified holding base of FIG. 14 in use;

FIG. 16 is a top plan view of an APPC embodiment with both top and side edge panels, for the horizontal APPC application;

FIG. 17 is a perspective view of an APPC sheet of an embodiment with a central release liner removed; it is positioned over the front surface of an iPod® Nano®;

FIG. 18 is a back view of a different embodiment of APPC sheet that is the same size as the front surface of an iPod®, and,

FIG. 19 is a top view of the APPC of FIG. 18 being applied to the front surface of an iPod®.

### DETAILED DESCRIPTION OF GUIDED PICTORIAL DRAWINGS

An adhesive backed film material is used to form the APPC of this invention. Polypropylene film with pressure sensitive hot melt rubber-resin adhesive can be used. It is similar to commercially available 3M® Scotch® packaging tape 3750. Thickness is about 2.0 mil of polypropylene substrate with about a 1.1 mil adhesive layer.

However, template tape must be manufactured to meet the size specifications of the music player. Appropriate release liners are attached.

For example, a typical iPod® has a height of 4.1 inches, width of 2.4 inches and a depth of 0.57 inches (including rounded corners).

However, a typical iPod Shuffle® has a height of 3.3 inches, width of 0.98 inches and a depth of 0.33 inches (including rounded corners).

Furthermore, a typical iPod Mini® has a height of 3.6 inches, width of 2.0 inches and a depth of 0.5 inches (including rounded corners).

Additionally, a special edition iPod Photo® has a height of 4.1 inches, width of 2.4 inches and a depth of 0.57 inches (including rounded corners).

Utilizing illustrations the consumer will be guided along and advanced through the bonding procedure by removing numbered adhesive release strips. With the removal of each numbered adhesive release strip one separate bonding procedure will be completed. A total of four adhesive release strips will be sequentially removed and secured into alignment with the longitudinal edge of the Apple® iPod® music player. Two of the release strips are located on the top surface at each side of the audio connection opening. The two remaining release strips are the front and rear panels. The front and rear panels also contain the material to complete bonding at bottom of the music player. The rear bonding panel provides a relief opening cut-out for the power supply.

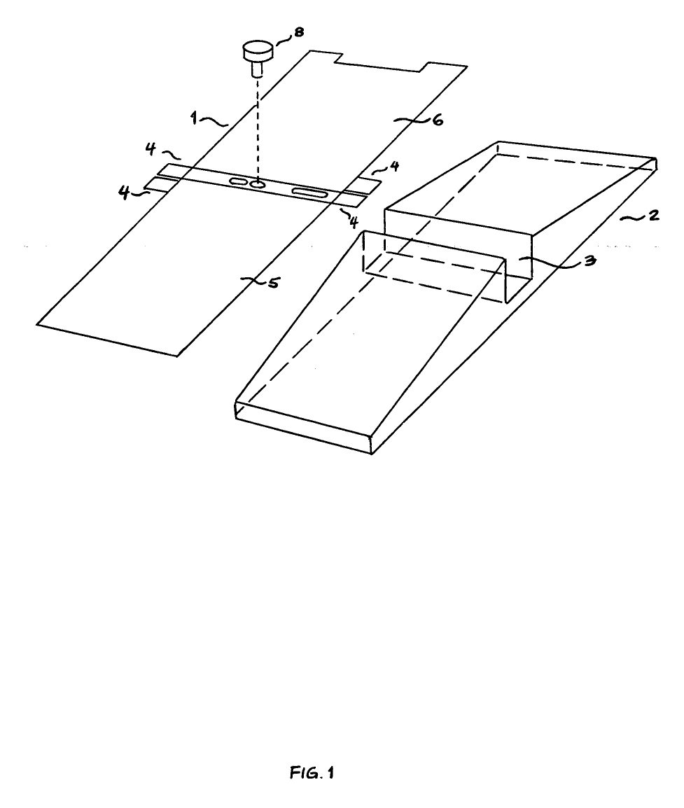

FIG. 1 shows APPC 1 along with the product clear case package 2 ready to accept and hold the Apple® iPod® music player in the upright position in formed recess 3. APPC 1 is shown with a total of four numbered adhesive release tabs 4. Also shown is the included installation centering pin 8 above the opening for the audio connection. All required openings for complete operation of the music player are pre-cut in the APPC 1. Minimal surface contact is sufficient to begin the bonding process and to achieve the correct APPC position. Also shown in FIG. 1 are front panel 5 and rear panel 6.

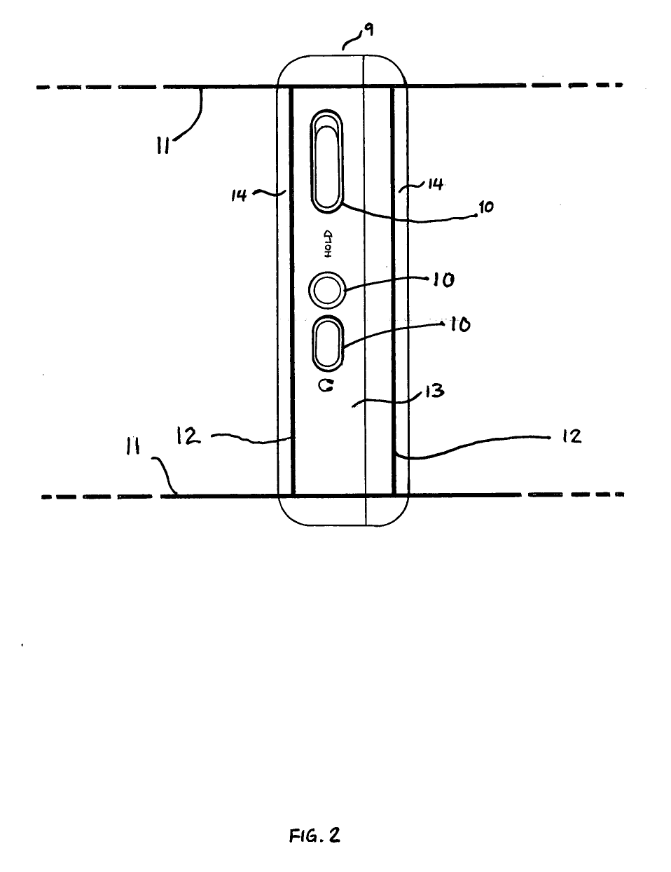

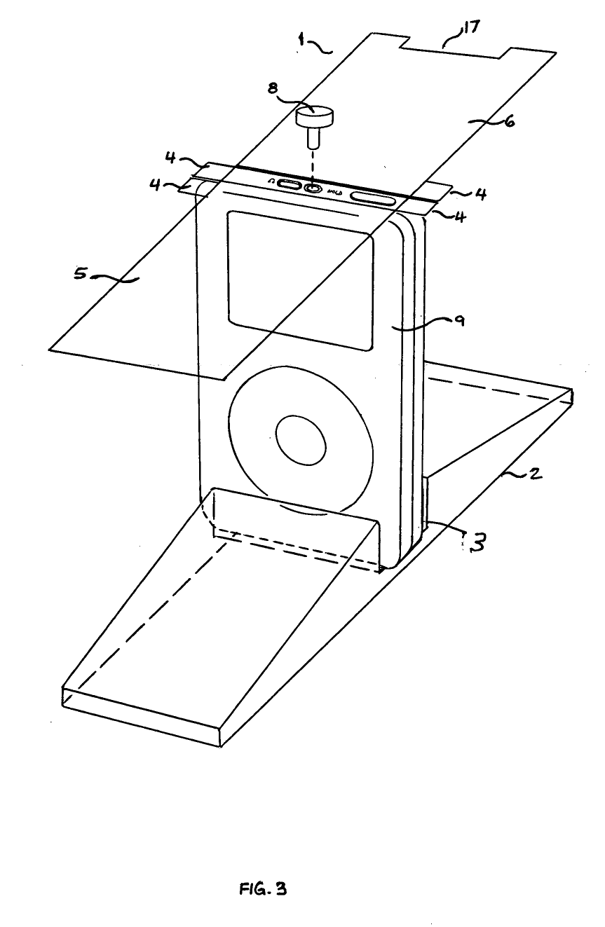

At FIG. 2 a top view is shown without centering alignment pin 8. Pin 8 has been removed to help understand placement of the APPC with respect to audio control openings 10 of music player 9. Also shown are edges 11 of APPC 1 at top surface bonding limits 12. Note that the APPC covers center flat surface area 13 of the top surface of music player 9 and does not extend over to the area of the radius of side curvature 14. The bonding at the top surface requires only a minimal surface area. The minimal surface contact is sufficient to begin the bonding process and to achieve the correct APPC position.

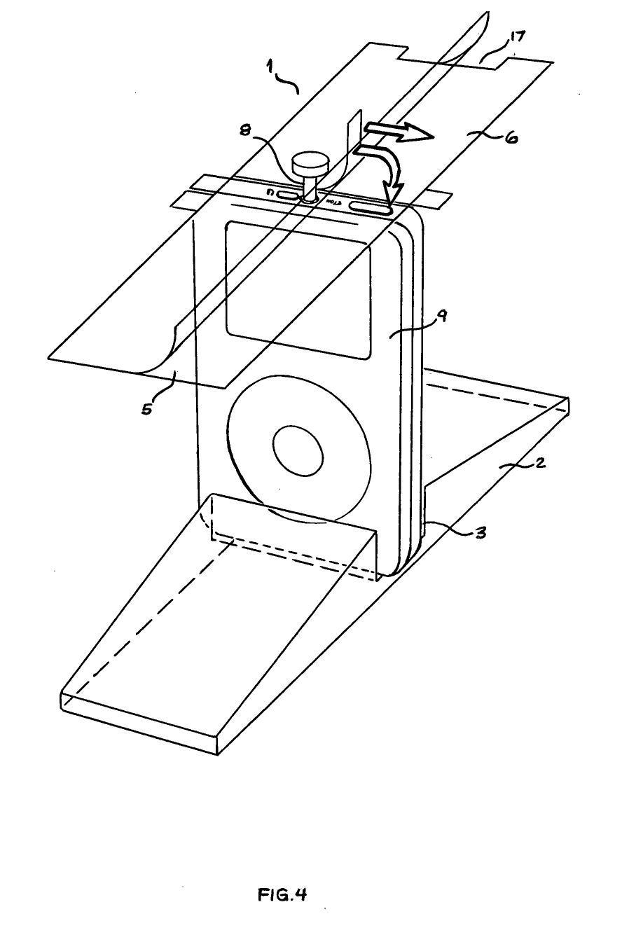

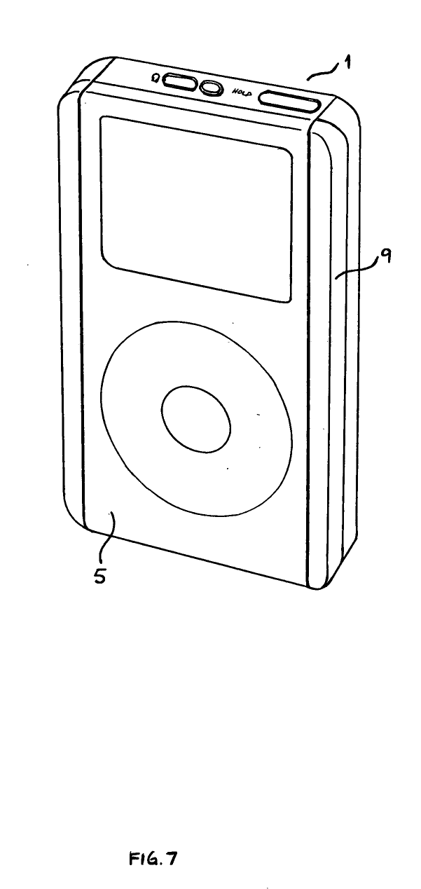

FIG. 3 shows APPC 1 in its correct position above music player 9 and ready to begin the phased removal process of adhesive release strips 4. Rear bonding panel 6 of APPC 1 has a pre-cut section removed from the rear-bonding panel. The rear panel of the APPC will continue down the back of the music player and fold around the bottom edge and stop at the power supply opening located on the bottom surface. See FIG. 6 for additional bonding details at the bottom surface of the music player.

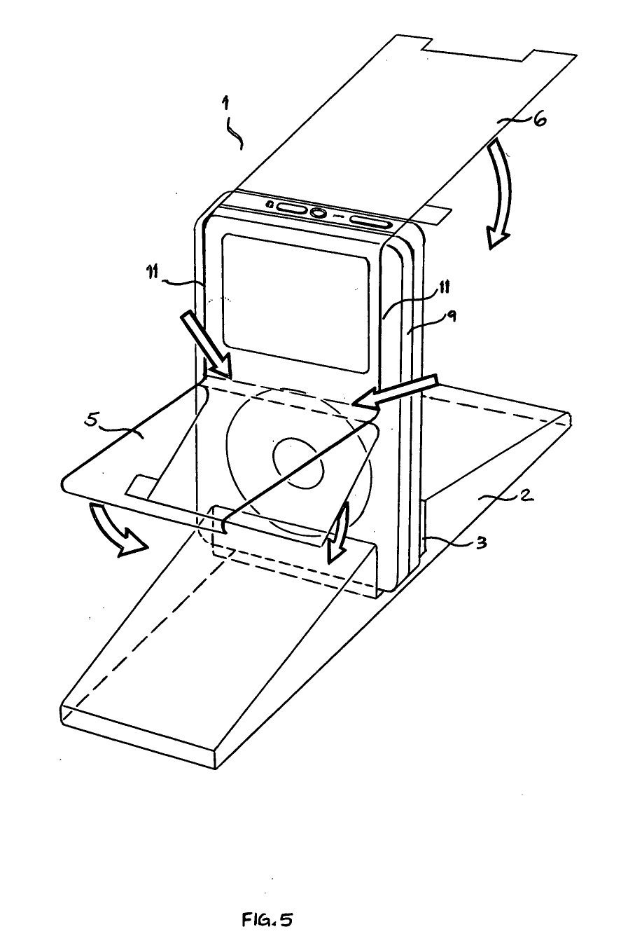

In FIG. 4 the Apple® iPod® music player 9 is shown located and fitted into the clear case package 2 holding location 3. Adhesive release strips one and two will be remove from the plastic protection cover during this phase of the bonding process. During this phase of the bonding procedure alignment centering pin 8 is shown inserted through APPC 1 and into audio connection opening 10. Centering pin 8 controls APPC 1 to the correct center location at the top surface of music player 9. Rotation of APPC 1 about centering pin 8 is controlled by pressing APPC 1 down and allowing the pre cut opening for the hold switch to pass over the raised hold switch and rest on the top surface of music player 9. Two points of centering have now been obtained and removal of the first two adhesive release strips may be started and completed. The release strips are numbered indicating the removal order.

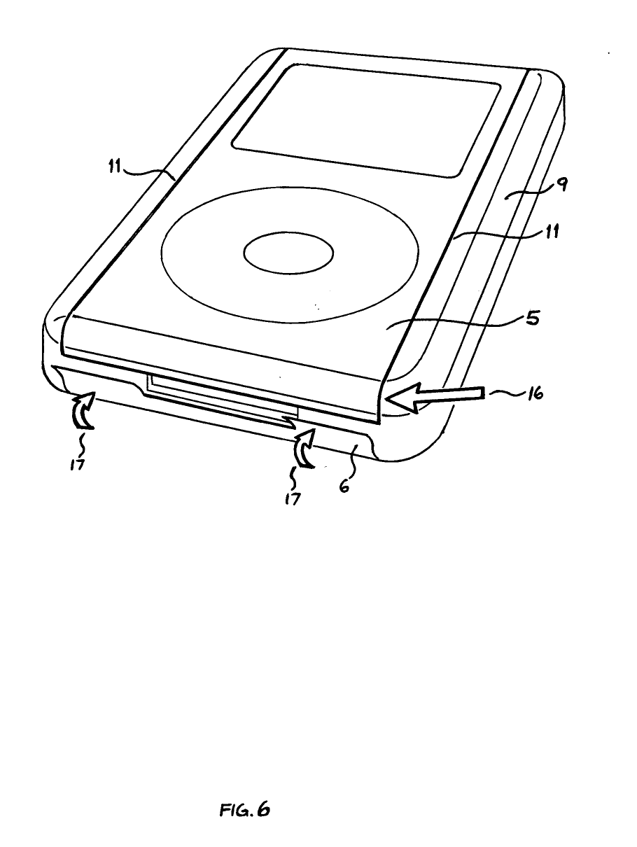

At FIG. 5 the music player may remain or be removed from package 2 holding location 3 and begin the bonding on the face of the music player. Adhesive tab number three is now ready to be removed. APPC 1 is designed to cover the entire face surface within outer bonding limits 11 shown in FIG. 4 and partially cover the bottom surface which meets the connection for the power supply shown at FIG. 6.

FIG. 6 shows the bottom surface of the music player with the final phase of the bonding procedure. Release strip three is shown completely removed and front panel 5 is in place along the top surface of the iPod music player 9, as indicated by right arrow 16. Back panel 6 is shown moving along the bottom lower radius of the music player and on up towards the final bonding position outlined at the bottom power supply opening, as indicated by the two arrows 17, with the release liner attached to tab 4 having been completely removed. The opening for the power supply should be completely free of any material from the APPC.

APPC 1 is shown in FIG. 7 with all bonding phases completed and correctly adhered to the top and front of music player 9. The protective cover should be smooth without any air bubbles or wrinkles, visually clear and barely noticeable. It is sufficiently pliable such that all touch control functions are operable through front panel 5.

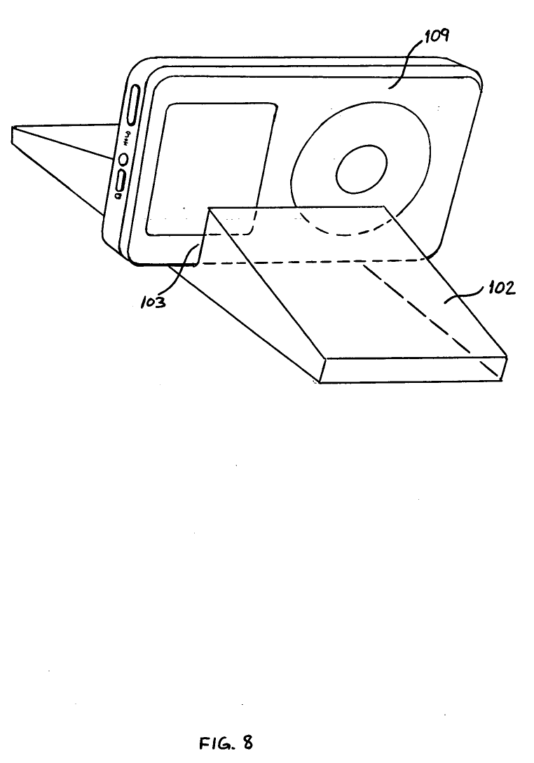

In FIGS. 8-13, transparent adhesive plastic protective cover (APPC) 101 can be applied to music player 109 seated in a side to side orientation position within recess 103 of holding cradle 102.

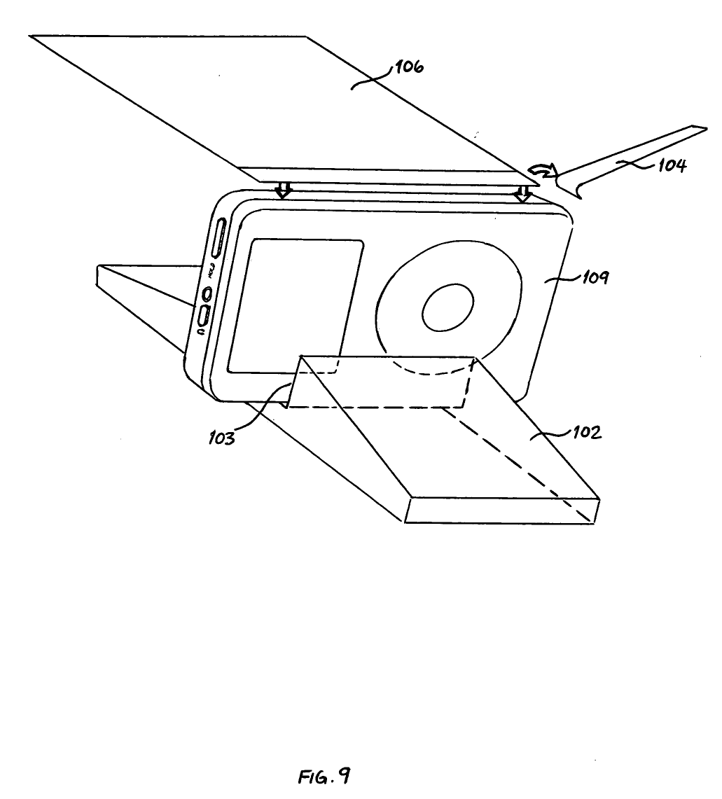

In this embodiment shown in FIGS. 8-13, APPC 101 consists of a front and a back adhesive panel centering pin 8 is not required. For example, as shown in FIG. 9, APPC 101 is first applied when an edge thereof is in positional register with a side seam of music player 109 after release liner strip 104 is removed to expose adhesive.

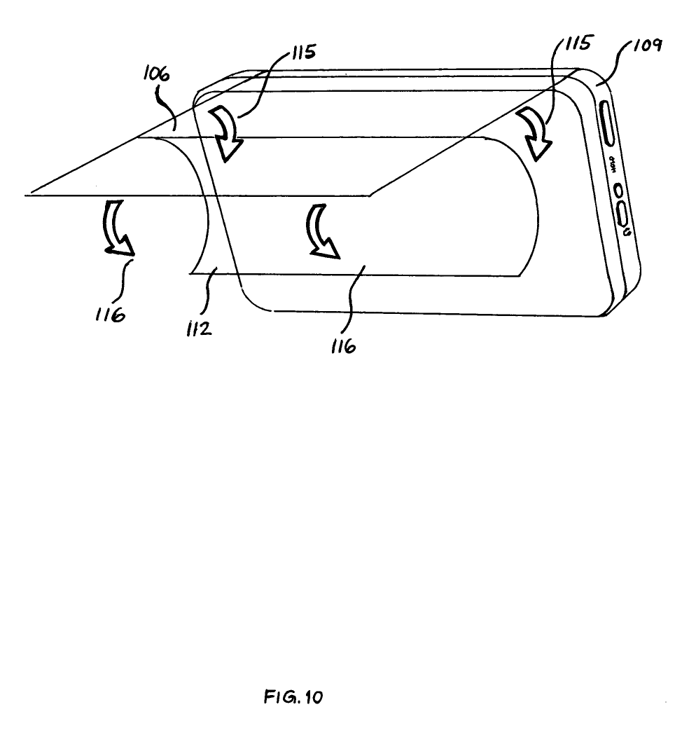

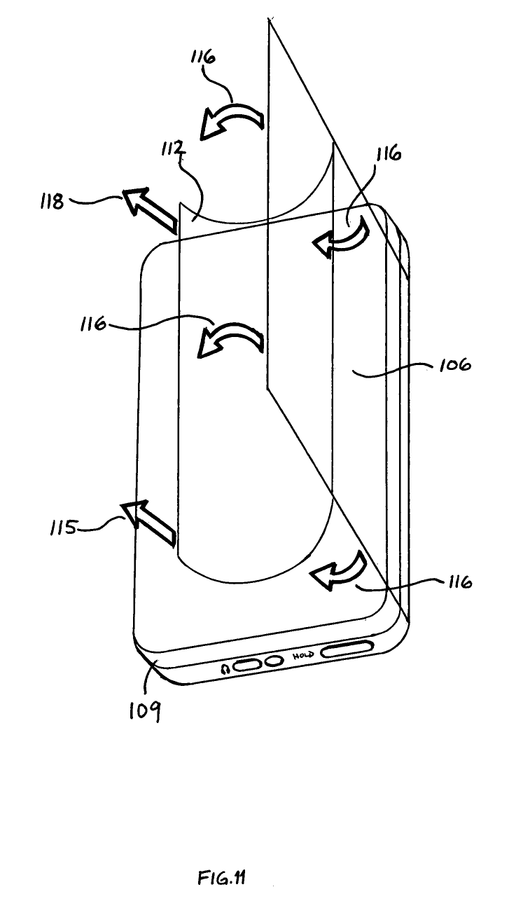

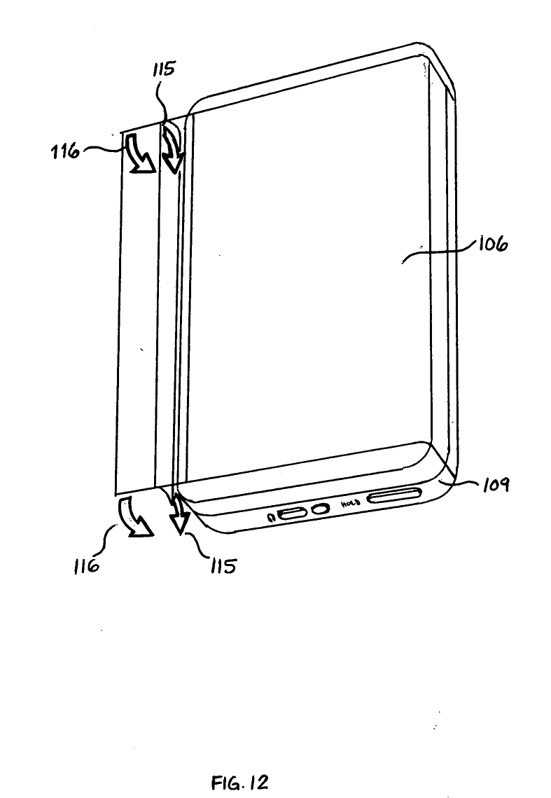

In FIGS. 10, 11 and 12, a planar release liner is removed from a surface of APPC 112 corresponding to a back surface of music player 109. In the two alternative views of FIGS. 10 and 11, installation of rear panel 106 is shown in process whereby release liner 1 12 is removed from panel 106 (see arrows 1 15), while panel 106 is folded down (arrows 116) to be adhered to music player 109 back surface. In FIG. 12, the final piece of release liner 112 is removed and panel 106 is folded over the side edge.

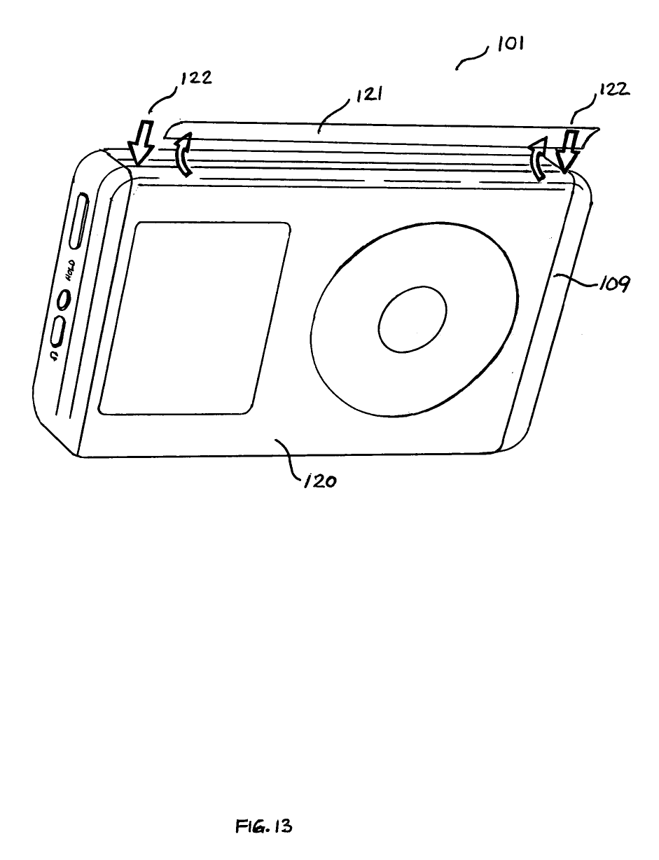

In FIG. 13, a further edge plane release liner strip 121 is removed to facilitate the application of panel 120 of APPC 101 to cover the front surface of music player 109. The edge of panel 120 is carefully aligned with the edge seam of player 109 at arrows 122. The rest of the procedure to install front panel 120 is a repeat of the steps illustrated in FIGS. 9-12 for installing back panel 106.

Note that in this embodiment, top and bottom ends of player 109 are not covered by APPC 101.

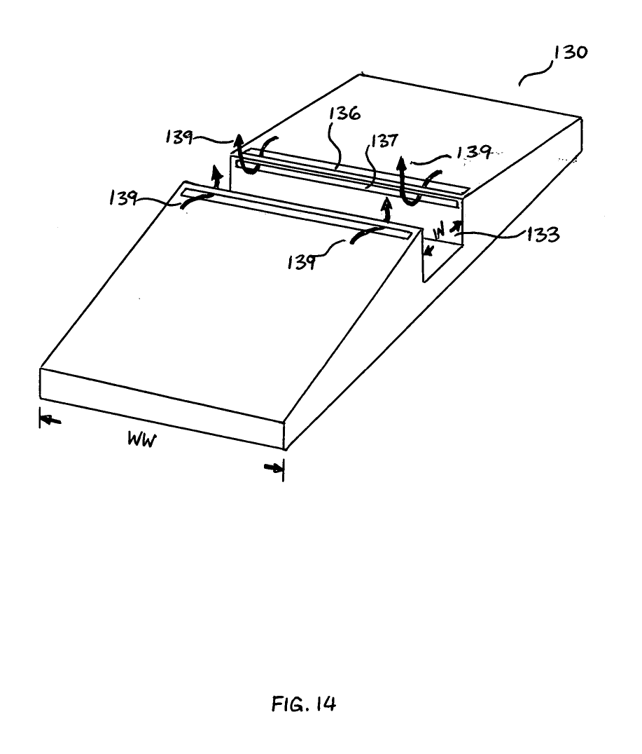

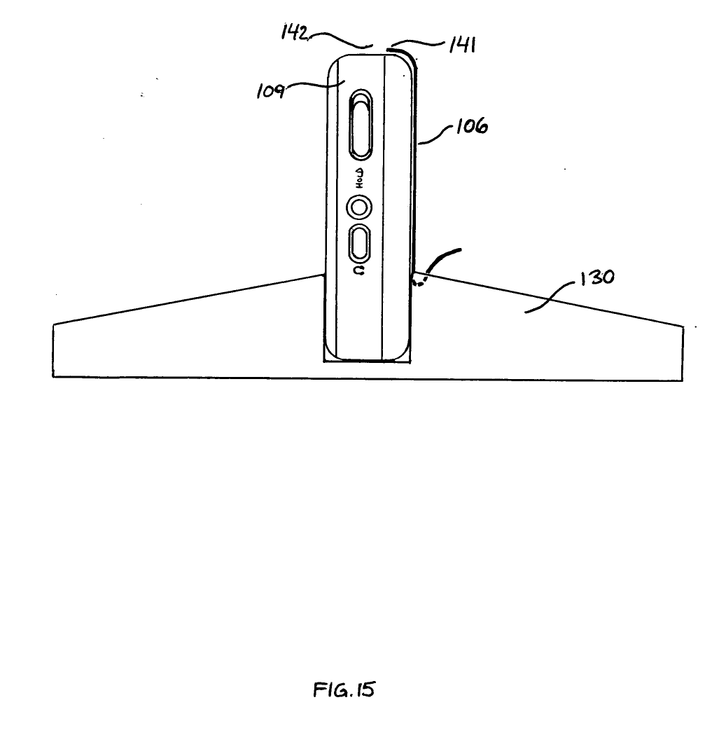

FIG. 14 shows an alternate embodiment of holding cradle 130 for holding music player 109 in a horizontal position. It is wider (dimension WW) than cradle 102 shown in FIG. 8. Recess 133 is also slightly wider (dimension W) to accommodate player 109 and front and back layers of APPC. Dimension WW is wider than either front panel 120 or back panel 106. Entry slots 136 and exit slots 137 near the top edge of recess 133 are sized to accept panels 120 and 106 (following path shown by arrows 139) in such a manner as to properly square the leading edge 141 so as to align with seam 142 of player 109 as shown in the end view of FIG. 15. Although a pair 136 and 137 of slots is shown near the top of each edge of recess 133, a single pair may be used. In either case, the paid of slots is an aid in initial alignment of the APPC panels.

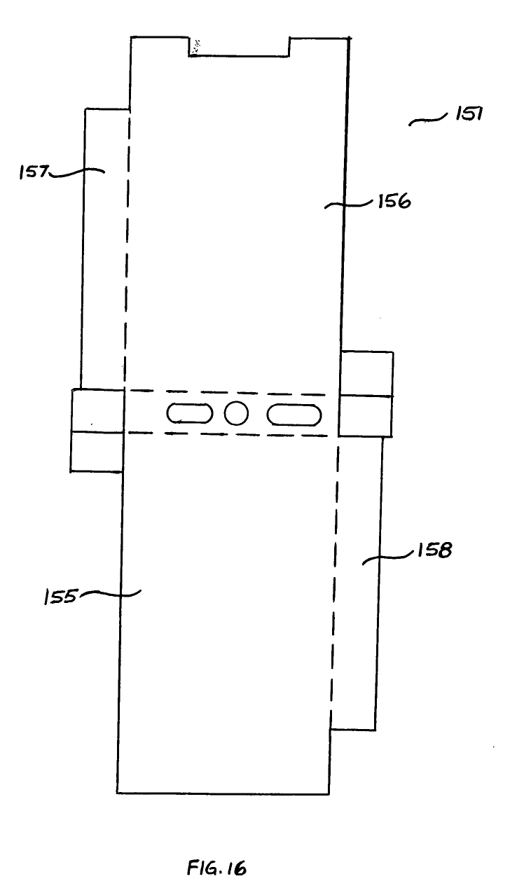

FIG. 16 shows yet another embodiment of APPC 151. This is similar to the first embodiment shown in FIGS. 1-7, but side panels 157 and 158 have been added. The dashed lines illustrate the bend locations.

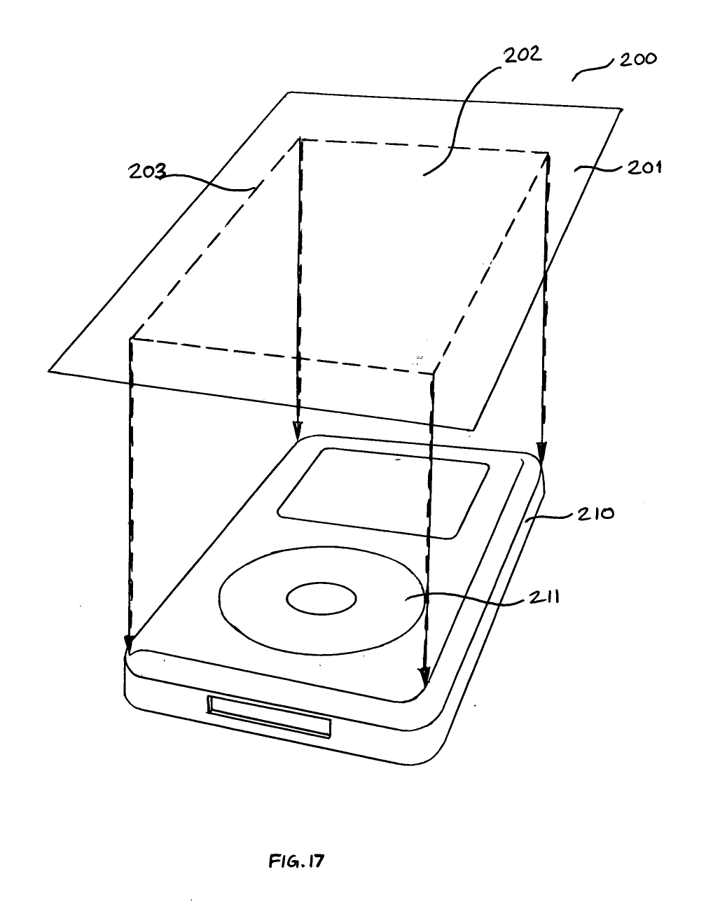

FIG. 17 is a perspective view of an APPC sheet 200 with border 201 around central plastic sheet window 202. The release liner has been removed from the back side of window 202 in this illustration, but edges 201 still have release liner covering the adhesive layer. Note that perforations 203 weaken the attachment of window 202 to edge 201. Sheet 200 is positioned over iPod Nano 210. Similar APPC sheets sized for the other iPod models can be used as well. Note that after alignment and attachment, circular seam 211 will be protected by the APPC layer of window 202. To complete the application, edge 201 is removed by simply applying force to cause the perforations to separate.

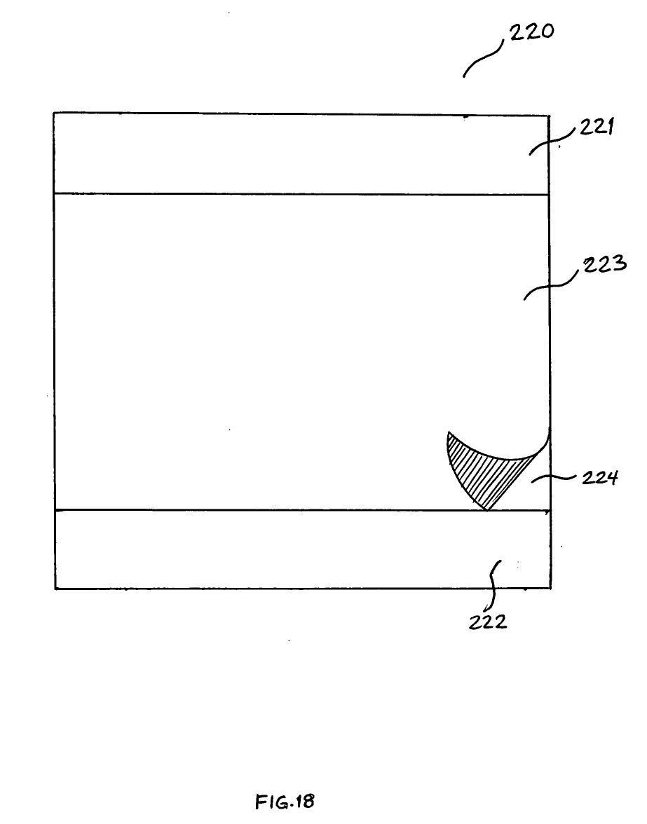

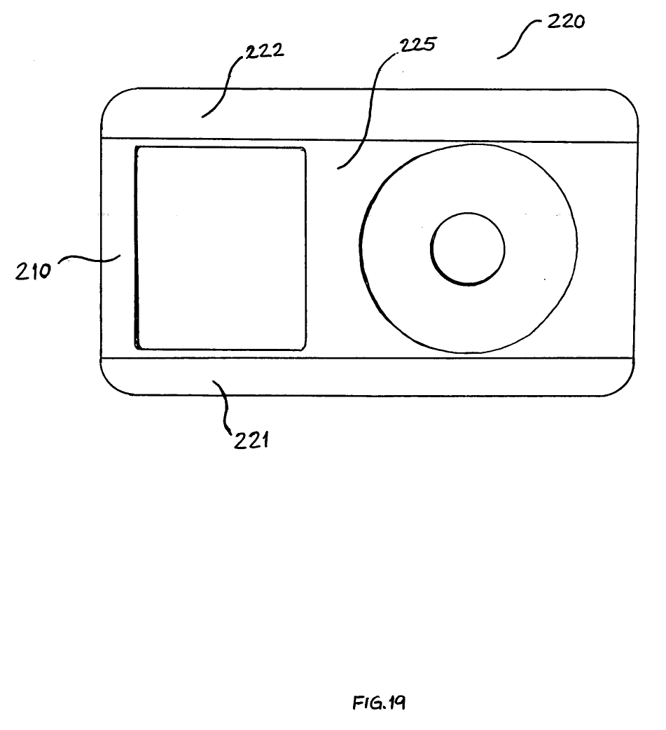

FIGS. 18 and 19 show an alternate embodiment of APPC sheet that is precut to the size of the iPod model for which it is intended. FIG. 18 is a back view of sheet 220 showing central panel of release liner 223 being peeled off exposing the adhesive layer 224 of the APPC plastic film. Edges 221 and 222 are protected with release liner through the initial alignment and attachment phase to provide an easy means to hold the APPC layer. FIG. 19 shows sheet 220 aligned over iPod® 210. The exposed adhesive surface is smoothed onto the iPod® surface. Then edges 221 and 222 are folded over so that edge release liners can be removed. After that, the edges themselves are pressed down and smoothed.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A method of using a thin film to protectively shield an electronic instrument comprising the steps of:
providing a portable music playback electronic instrument having a housing front, rear, top, bottom and side surfaces,
said front face having a viewable display screen and an open circular seam surrounding a touch sensitive control wheel, said viewable display screen being spaced apart on said front face from said open circular seam surrounding said touch sensitive control wheel, and
providing a thin, flexible, transparent, plastic film panel, and
completely applying and adhering the panel to the front surface portion of the portable music playback electric instrument; whereby manual operation of said touch sensitive control wheel is permitted.

2. The method of claim 1 further comprising the step of:
prior to applying and adhering said panel, standing said portable music playback electronic instrument in a holding docking said base having a well for receiving a portion of said portable music playback electronic instrument to permit application of said cover.

3. The method of claim 1 wherein the thin film providing step further comprises the step of:
providing a release tab upon a contact side of said film panel and removing said release tab prior to application of said panel upon said front surface portion of said portable music playback electronic instrument.

4. The method of claim 1 further comprises the step of providing said panel as a template having further sub panels for covering at least one of said rear, top, bottom and side edges of said portable music playback electronic instrument.

5. An assembly of a thin film to protectively shield an electronic instrument comprising in combination:
a portable music playback electronic instrument having a housing front, rear, top, bottom and side faces,
said front face having a viewable display screen and an open circular seam surrounding a touch sensitive control wheel, said viewable display screen being spaced apart on said front face from said open circular seam surrounding said touch sensitive control wheel and
a thin, flexible, transparent, plastic film panel, and
said thin, flexible transparent film panel being applied and adhered to the front surface portion of the portable music playback electric instrument; whereby manual operation of said touch sensitive control wheel is permitted.

6. The assembly of claim 5 further comprising:
a holding docking said base having a well receiving a portion of said portable music playback electronic instrument to permit application of said cover.

7. The assembly of claim 5 further comprising:
a removable release tab being provided upon a contact side of said film panel and said release tab being removed prior to application of said panel upon said front surface portion of said portable music playback electronic instrument.

8. The assembly of claim 5 further comprising said thin film panel being a template having further sub panels covering at least one of said rear, top, bottom and side edges of said portable music playback electronic instrument.

9. A method of applying an adhesive plastic cover to a portable hand held electronic music playback device comprising the steps of:
standing said electric device upright on a base, said device having a first face, an opposite second face, top and bottom surfaces, and side surfaces, said base having a well for receiving a lower portion of said device and retaining said device in an upright position to permit application of said cover;
placing a preshaped sheet of said cover on said top surface of said device, said cover having an opening corresponding to an opening in the top surface of said device;
inserting a male member through said cover opening into said device opening to orient said preshaped sheet of said cover on said device;
pulling a first tab attached to a first adhesive strip under said cover lying on said top surface on one side of said cover opening, said first adhesive strip sized and aligned with a corresponding top surface underneath said cover allowing adhesive bonding to take place;
pulling a second tab attached to a second adhesive strip under said cover lying on said top surface on an opposite side of said cover opening, said second adhesive strip sized and aligned with a corresponding top surface underneath said cover allowing adhesive bonding to take place;
pulling a third tab attached to a third adhesive strip covering an adhesive surface under said cover on one side of said top surface for engaging said first face of said device;
overlapping said first face with a portion of said cover having the third adhesive strip removed thereby bonding said cover with said first face underlying said cover;
pulling a fourth tab attached to a fourth adhesive strip covering an adhesive surface under said cover on an opposite side of said of said top surface for engaging the second face of said device; and
overlapping said second face of said device with a portion of said cover having the fourth adhesive strip removed thereby bonding said cover with said second face underlying said cover, whereby said first and second faces and said top surface of said device are provided with a protective coating.

10. The method of claim 9 in which cover is aligned on said device by placing a precut opening in said cover over a raised hold switch on said top surface of said device.

11. The method of claim 9 in which said cover overlaps a portion of said bottom surface of said device.

12. An adhesive plastic cover for, and in combination with, a hand held portable music playback device comprising:
said cover preshaped to cover first and second faces, and top and bottom surfaces of said device;
a strip in a midsection of said cover corresponding to said top surface of said device;
an opening in said strip corresponding to an opening in said top surface of said device for allowing centering of said cover on said top surface of said device;
a first adhesive layer covering said strip on one side of said opening in said strip;
a second adhesive layer covering said strip on an opposite side of said opening in said strip;
a first release tab connected to an adhesive release covering for said first adhesive layer;
a second release tab connected to an adhesive release covering for said second adhesive;
a third release tab connected to an adhesive release covering for an adhesive layer on said cover on one side of said strip; and
a fourth release tab connected to an adhesive release covering for an adhesive layer on said cover on an opposite side of said strip.
